(19) United States
(12) Patent Application Publication
(10) Pub. No.: US 2008/0307604 A1
(43) Pub. Date: Dec. 18, 2008

(54) Fastening-free door stopper

(76) Inventor: Mason Hee Kwong Leung, Temple City, CA (US)

Correspondence Address: DAVID AND RAYMOND PATENT FIRM, 108 N. YNEZ AVE., SUITE 128, MONTEREY PARK, CA, 91754, US

(21) Appl. No.: 11/818,662

(22) Filed: Jun. 14, 2007

(51) Int. Cl. E05F 5/02

(52) U.S. Cl. 16/82

(57) ABSTRACT

A fastening-free door stopper, for a door having a door knob, includes a hanging device adapted for coupling with a neck portion of the door knob and a stopper article, having a force absorbing ability, being suspendedly hung down by the hanging device below the door knob. The stopper article has a biasing side and an opposed stopping side and defining a safety distance between the biasing side and the stopping side larger than a length of the door knob. Therefore, when the stopper article is suspendedly hung, the biasing side of the stopper article is adapted for biasing against a door surface, such that the stopper article is adapted for absorbing an impact force when the door is fully opened so as to prevent the door being snapped to a nearby wall.

### BACKGROUND OF THE PRESENT INVENTION

1. Field of Invention

This invention is related to a door stopper, and more particularly to a fastening-free door stopper which adapted to be hung at the door without any fastening tool for absorbing an impact force when the door is fully opened to prevent the door knob from damaging the wall as well as the door knob itself.

2. Description of Related Arts

Door stoppers are widely used in our daily life. When people snap the door without a door stopper, the door knob will hit the nearby wall and cause damages either on the wall or on the door knob itself. This will not only structurally damage the wall, but also make the wall less aesthetic in appearance.

Normally, a door stopper is aligned with the door knob and located on the nearby wall so that when the door is snapped and fully opened, the door stopper will prevent the door knob from directly hitting on the wall and absorb the impact coming from the door knob. The door stopper is usually fastened on the nearby wall with a plurality of screws which will consequently damage the nearby wall by drilling holes thereat. Furthermore, if there is a misalignment between the door stopper and the door knob, the door knob will still hit the nearby wall when the door is snapped and fully opened. In addition, the door stopper appears bulky on the nearby wall and thus lowers the aesthetic value thereof.

Another kind of door stopper is made by an elongated spring extended from the lower corner of the door. The elongated spring is longer than the door knob so when the door is fully opened, the elongated spring will thus hit the nearby wall before the door knob. The elongated spring door stopper is smaller in size compared to the door stopper stated previously and since it is located at the lower corner of the door, its existence is not obvious. However, it is more difficult to install a door stopper on the door than on the wall since the door is usually made by solid wood which is much harder than the wall. Also, installing a door stopper on the door will damage the door itself. The elongated spring door stopper has another limitation that it is structurally weaker and easier to break.

### SUMMARY OF THE PRESENT INVENTION

A main object of the present invention is to provide a fastening-free door stopper, wherein the fastening-free door stopper comprises a hanging device adapted for coupling with a neck portion of the door knob, and a stopper article with a force absorbing ability suspendedly hung down by the hanging device below the door knob. When the door is fully opened, the stopper article is adapted for absorbing an impact force to prevent the door knob from damaging the wall as well as the door knob itself.

Another object of the present invention is to provide a fastening-free door stopper, wherein the stopper article comprises an impacting head frontwardly extended from the lower portion of the hanging panel and a retention base rearwardly extended therefrom.

Another object of the present invention is to provide a fastening-free door stopper, wherein the stopper article is integrally extended from the hanging device to form a one-piece structure.

Another object of the present invention is to provide a fastening-free door stopper, wherein the stopper article is made of foaming material for absorbing the impact force when the door is fully opened.

Another object of the present invention is to provide a fastening-free door stopper, wherein the hanging panel has a holding slot provided at the lower portion, wherein the stopper article can deformably pass thorough the holding slot to replaceably mount the stopper article at the lower portion of the hanging panel.

Another object of the present invention is to provide a fastening-free door stopper, wherein the stopper article is an inflatable article for absorbing the impact force when the door is fully opened.

Another object of the present invention is to provide a fastening-free door stopper, wherein the hanging device comprises a hanging cable having two ends affixing to the stopper article to define a hanging loop for being held at the neck portion of the door knob so as to retain the stopper article below the door knob.

Another object is of the present invention is to provide a fastening-free door, wherein the stopper article and the hanging panel are inflatable articles and are integrally formed as a one-piece door stop, such that when the door stop, such that when the door stop is inflated, an upper portion of the door stop forms the hanging panel while a lower portion of the door stop forms the hanging article.

Accordingly, in order to accomplish the above objects, the present invention provides a fastening-free door stopper, which comprises:

a hanging device adapted for coupling with a neck portion of said door knob; and

a stopper article, which has a force absorbing ability, being suspendedly hung down by said hanging device below said door knob, wherein said stopper article has a biasing side and an opposed stopping side and defining a safety distance between said biasing side and said stopping side larger than a length of said door knob, wherein when said stopper article is suspendedly hung, said biasing side of said stopper article is adapted for biasing against a door surface, such that said stopper article is adapted for absorbing an impact force when said door is fully opened so as to prevent said door being snapped to a nearby wall.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a fastening-free door stopper according to a first preferred embodiment of the present invention.

FIG. 2 is a sectional view of the fastening-free door stopper according to the above first preferred embodiment of the present invention.

FIG. 3 illustrates a first alternative mode of the fastening-free door stopper according to the above first preferred embodiment of the present invention.

FIG. 4 illustrates a second alternative mode of the fastening-free door stopper according to the above first preferred embodiment of the present invention.

FIG. 5 is a perspective view of a fastening-free door stopper according to a second preferred embodiment of the present invention.

FIG. 6 is a perspective view of a fastening-free door stopper according to a third preferred embodiment of the present invention.

FIG. 7 is a perspective view of a fastening-free door stopper according to a fourth preferred embodiment of the present invention.

### DETAILED DESCRIPTION OF THE PREFERRED EMBODIMENTS

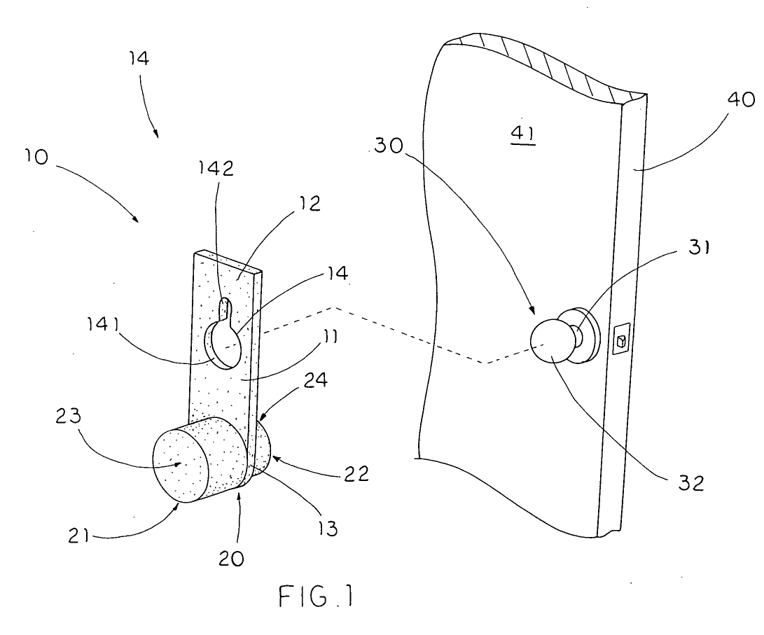

Referring to FIG. 1 of the drawings, a fastening-free door stopper according to a first preferred embodiment is illustrated, wherein the fastening-free door stopper is adapted for hanging at the door 40 having a door knob 30.

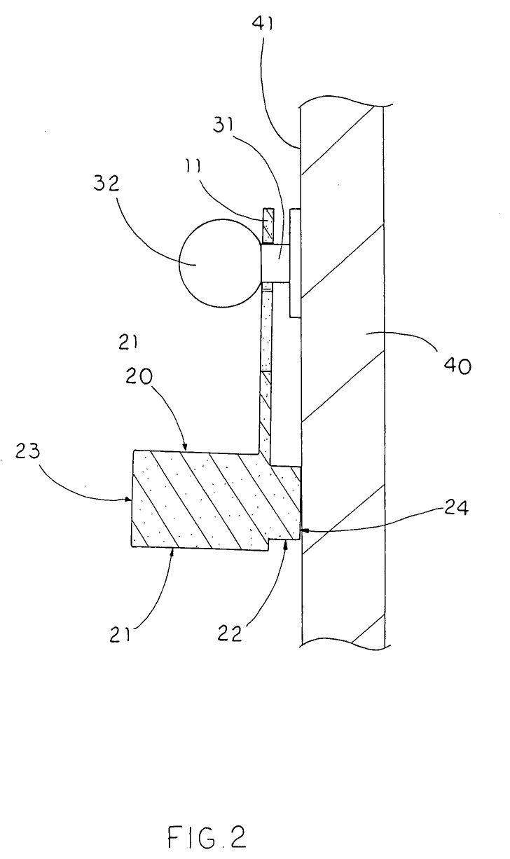

As shown in FIGS. 1 and 2, the fastening-free door stopper comprises a hanging device 10 adapted for coupling with the door 40 in a tool free manner and a stopper article 20 which has a force absorbing ability.

The stopper article 20 is suspendedly hung down by the hanging device 10, wherein the stopper article has a biasing side 22 and an opposed stopping side 23 and defining a safety distance between the biasing side 22 and the stopping side 23 larger than a length of the door knob 30. Accordingly, when the stopper article 20 is suspendedly hung, the biasing side 22 of the stopper article 20 is adapted for biasing against a door surface 41, such that the stopper article 20 is adapted for absorbing an impact force when the door 40 is fully opened so as to prevent the door 40 being snapped to a nearby wall.

According to the preferred embodiment, the hanging device 10 comprises a hanging panel 11 having an upper portion 12, a hanging slot 14 formed thereat for being held at the neck portion 31 of the door knob 30, and a lower portion 13 retaining the stopper article 20 in position so as to retain the stopper article 20 below the door knob 30. The hanging slot 14 has a lower slot portion 141 having a size slightly larger than a size of a head portion 32 of the door knob 30, and an upper slot portion 142 having a size slightly larger than a size of the neck portion 31 of the door knob 30, such that the hanging panel 11 is adapted for being hung at the door knob 30 to retain the stopper article 20 at a position below the door knob 30.

The stopper article 20 comprises an impacting head 21 and a retention base 22, wherein the impacting head 21 frontwardly extended from the lower portion 13 of the hanging panel 10 and the retention base 22 rearwardly extended therefrom. The impacting head 21 defines the stopping side 23 for facing towards the nearby wall when the door 40 is opened, while the retention base 22 defines the biasing side 24 for biasing against the door surface 41, as shown in FIG. 2. It is worth to mention that the stopper article 20 in this embodiment is integrally extended from the hanging device 10 to form a one-piece structure. Preferably, the hanging device 10 and the stopper article 20 are made of foam material for absorbing the impact force when the door 40 is fully opened.

As shown in FIG. 2, in order to protect the door knob 30 from hitting the nearby wall when the door is fully opened, a safety distance which is larger than the length of the door knob 30 is defined as the distance between the biasing side 24 and the stopping side 23, namely the length of the stopper article 20. More specifically, the thickness of the retention base 22 is at least equal to the length of the neck portion 31 of the door knob 30 so as to prevent the hanging panel 11 from being backwardly slid along the neck portion 31 of the door knob 30 and at least stay parallel to the door surface 41. Preferably, the thickness of the retention base 22 is slightly larger than the length of the neck portion 31 of the door knob 30 so that the upper portion 12 of the hanging panel 11 is closer to the door surface 41 while the lower portion 13 is farer therefrom. Namely, the entire hanging panel 11 is slightly inclined and the inclined hanging panel guarantees that the hanging panel 11 is not backwardly slid along the neck portion 31 of the door knob 30. It is worth mentioning that “a door is fully open” means the door 40 is not able to move any further toward the nearby wall.

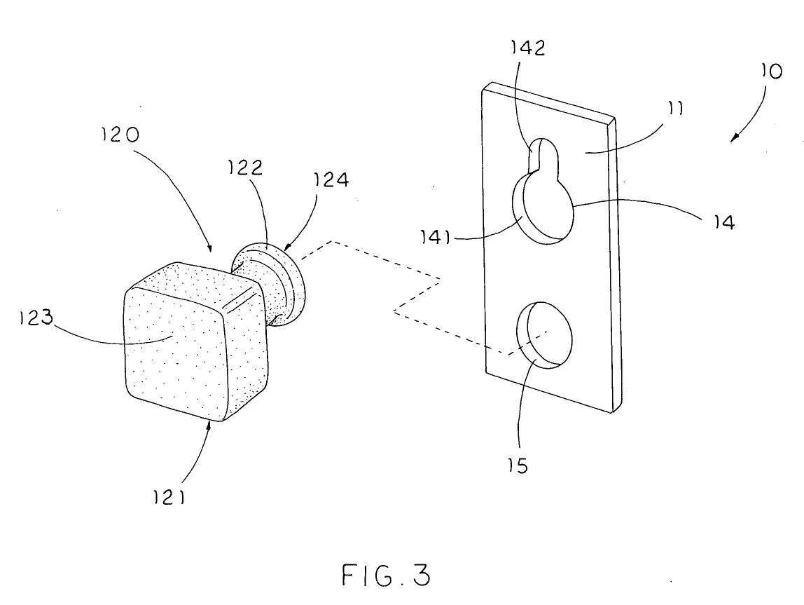

FIG. 3 illustrates an alternative mode of the fastening free door stopper of the first embodiment, wherein the stopper article 120 is detachably coupled with the hanging device 10. As shown in FIG. 3, the lower portion 13 of the hanging panel 11 has a holding slot 15, wherein the retention base 122 of the stopper article 120 is deformably passed through the holding slot 15 to replaceably mount the stopper article 120. The stopper article 120 in this alternative is usually made by soft materials which can be easily deformed and have some extent of elasticity, such as rubbers, sponges and foaming materials. With its inherent elasticity, the stopper article 120 can be squeezed into the holding slot 15 and mounted at an appropriate position of the hanging panel 11 so as to retain the impacting head 121 frontwardly protruding from the hanging panel 11 and the retention base 122 rearwardly protruding from the hanging panel 11.

The safety distance concept is also applied in this alternative. In order to protect the door knob 30 from hitting the nearby wall when it is fully opened and to prevent the hanging panel 11 from being backwardly slid along the neck portion 31 of the door knob 30 as it is mentioned in FIG. 2, the distance between the biasing side 124 and the stopping side 123, namely the length of the stopper article 120, should be at least equal to the length of the door knob 30. Preferably, the length of the stopper article 120 is longer than the door knob 30 and the length of the retention base 122 is slightly longer than the neck portion 31 of the door knob 30 so that the hanging panel 11 is slightly inclined as illustrated in FIG. 2.

Instead of being integrally extended from the hanging device 10, the stopper article 120 in the present embodiment is squeezed into the holding slot 15 and the stopper article is thus replaceable. It is convenient for the user to replace the stopper article 120 when it is worn or not in a good working condition. In addition, since the hanging panel 11 is preferably made by plastic and the stopper article 120 is made by soft materials, the manufacturing costs are lower than conventional door stoppers so that the user can purchase a door stopper with lower price without sacrificing essential functions.

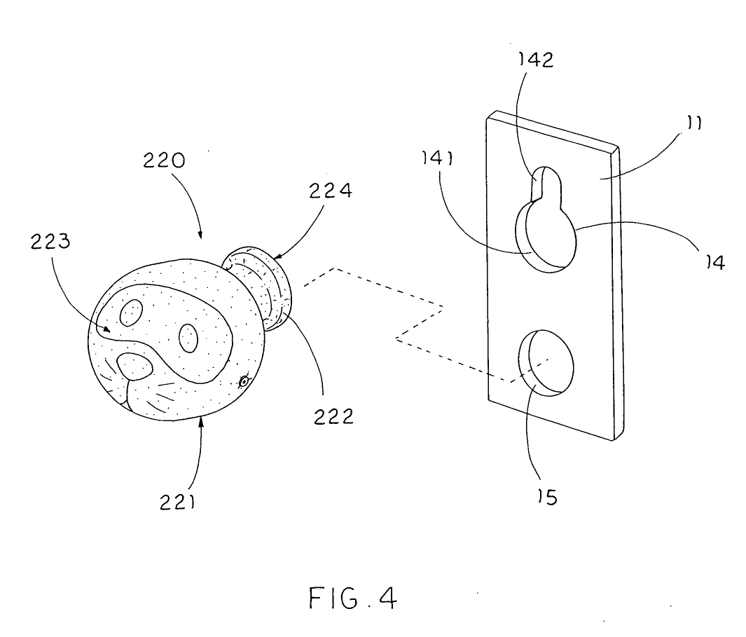

FIG. 4 illustrates another alternative mode of the first embodiment wherein the stopper article is an inflatable article 220. Preferably, the inflatable article 220 is squeezed into the holding slot 15 of the hanging panel 11 when the inflatable article 220 has not yet been inflated, wherein the user can adjust and mount the inflatable article 220 to an appropriate position of the hanging panel 11. The user can then inflate the article 220 until the distance between the biasing side 224 and the stopping side 223, namely the length of the stopper article 220, is at least equal or slightly longer than the length of the door knob based on the safety distance concept illustrated previously.

In order to market the door stopper in this embodiment to be more attractive to young children, animation figures or pictures can be printed onto the surface of the impacting head 221, wherein when the article is inflated, the figures or pictures on the impacting head surface become more vivid so as to attract more children and parents to purchase the door stopper. Thus, the door stopper in this embodiment can not only serve the function of preventing the door from hitting the nearby wall when fully opened, but also serve the function of entertainment.

Furthermore, the inflatable article 220 in this embodiment is replaceable because it is not integrally extended from the hanging panel 11. Users can replace the inflatable article when it is worn or not in good working condition. Children may want to replace this article when the animation figures or pictures no longer interest them even though the article is still in good working condition.

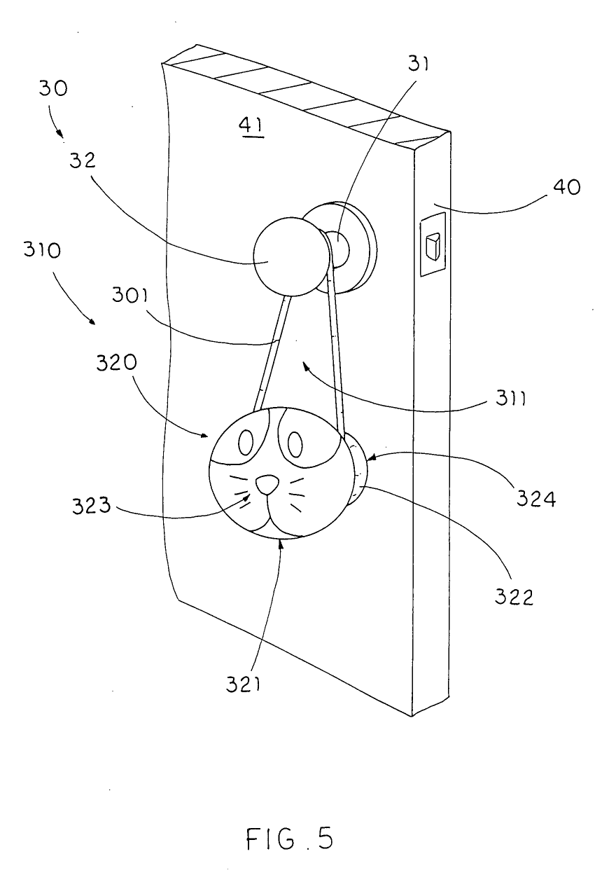

As shown in FIG. 5, a fastening free door stopper of a second embodiment illustrates an alternative mode of the first embodiment of the present invention, wherein the fastening free door stopper comprises a hanging device 310 and a stopper article 320.

According to the second embodiment, the hanging device 310 comprises a hanging cable 301 having two ends affixing to the stopper article 320 to define a hanging loop 311 for being held at the neck portion 31 of the door knob 30 so as to retain the stopper article 320 below the door knob, as shown in FIG. 5.

The stopper article 320 comprises an impacting head 321 and a retention base 322 integrally and rearwardly extended therefrom, wherein the two ends of the hanging cable 301 are affixed to the stopper article 320 between the impacting head 321 and the retention base 322. Likewise, the impacting head 321 defines the stopping side 323 for facing towards the nearby wall when the door 40 is opened, while the retention base 322 defines the biasing side 324 for biasing against the door surface 41, as shown in FIG. 5. A safety distance, which is larger than the length of the door knob 30, is defined as the distance between the biasing side 324 and the stopping side 323, namely the length of the stopper article 320.

Like previous two embodiments, the stopper article 320 is not integrally extended from the hanging loop 311 so the stopper article 320 is replaceable based on the user's desire. The stopper article 320 can be made by plastic or soft materials, or the inflatable article. Like prior embodiment regarding the inflatable article, animation figures or pictures can be printed onto the surface of the impacting head 321 so as to attract young children and their parents to purchase the door stopper. Again, the door stopper in this embodiment can not only serve the function for preventing the door from hitting the nearby wall when fully opened, but also serve the function for entertainment. The safety distance concern is identical to prior embodiments, which means the distance between the biasing side 324 and the stopping side 323 is at least equal or slightly longer than the length of the door knob.

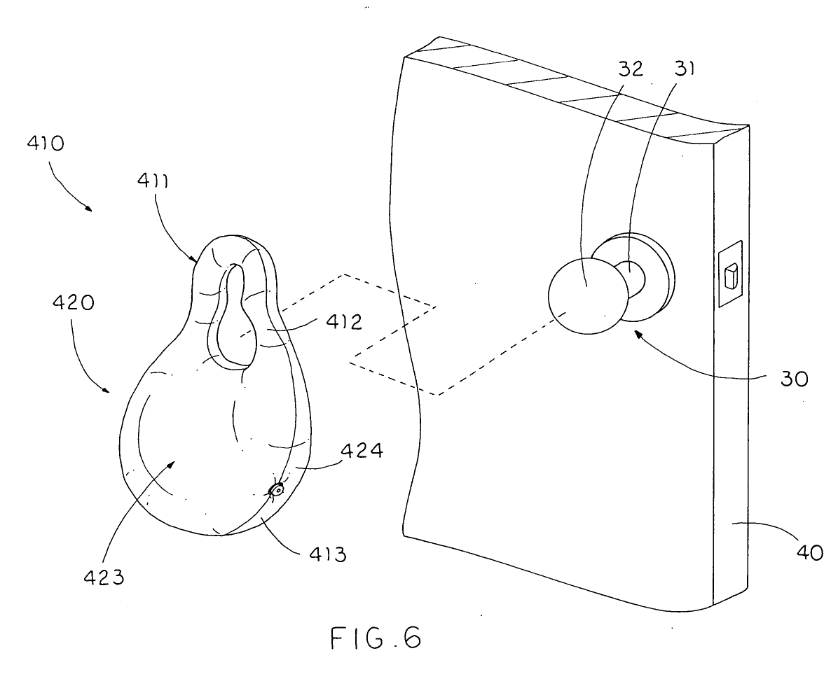

As shown in FIG. 6, a fastening free door stopper of a third embodiment illustrates an alternative mode of the first embodiment of the present invention, wherein the fastening free door stopper comprises a hanging device 410 and a stopper article 420. Referring to FIG. 6, the stopper article 420 and the hanging panel 411 of the handing device 410 are inflatable articles and are integrally formed as a one-piece door stop, such that when the door stop is inflated, an upper portion 412 of the door knob forms the hanging panel 411 while a lower portion 413 of the door stop forms the stopper article 420. Without sacrificing the function for preventing the door 40 from hitting the nearby wall, the door stopper in this embodiment provides more entertaining effect because the animation pictures or figures can be printed on the entire body of the door stopper so as to provide the art designer a larger space for artistic creation.

As to the concern of safety distance in the present embodiment, the distance from the stopping side 423 to the biasing side 424 is controlled by the amount of air contained in the lower portion of the hanging device 410, such that the more the air flows into the lower portion of the hanging device 410, the longer the distance from the stopping side 423 to the biasing side 424. The inflatable article can be inflated until the distance from the stopping side to the biasing side is at least equal or slightly longer than the length of the neck portion 31 of the door knob 30.

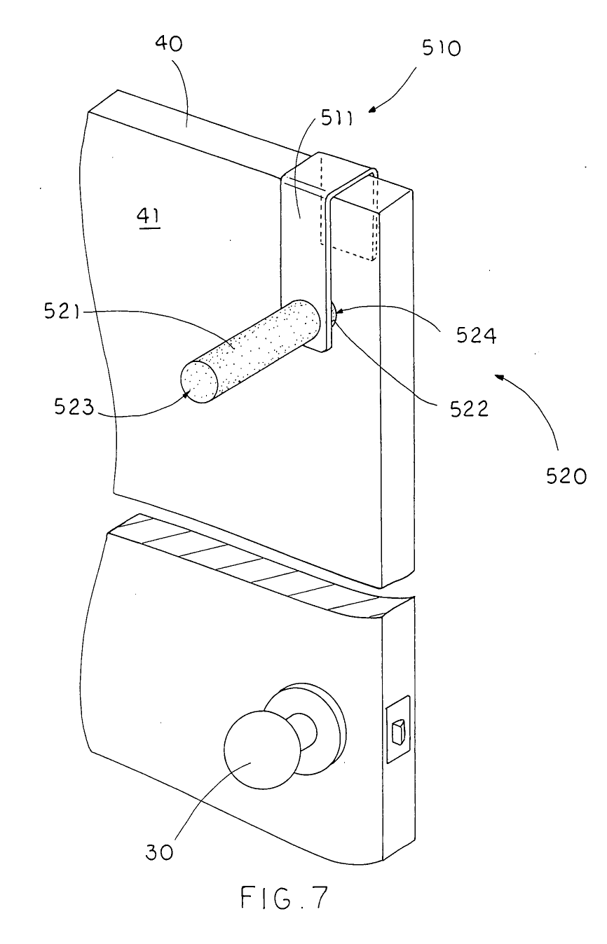

As shown in FIG. 7, a fastening free door stopper of a fourth embodiment illustrates an alternative mode of the first embodiment of the present invention, wherein the fastening free door stopper comprises a hanging device 510 and a stopper article 520.

The hanging device 510 comprises an edge hanger 511 having an upper portion adapted for hanging at a top edge of the door 40, and a lower portion coupling with said stopper article 520. As shown in FIG. 7, the upper portion of the edge hanger 511 has a U-shaped structure adapted for hanging at the top edge of the door 40, wherein the size of the upper portion of the edge hanger 511 is slightly larger than a thickness of the door 40. It is worth to mention that the edge hanger 511 is adapted to hang at the top edge of the door 40 when the door is opened.

The stopper article 520 comprises an impacting head 521 frontwardly extended from the lower portion of the edge hanger 511 to define a stopping side 523 for facing towards the nearby wall when the door is opened, and a retention base 522 rearwardly extended from the lower portion of the edge hanger 511 to define a biasing side 524 for biasing against the door surface 41. Accordingly, the stopper article 520 is made of foaming material for absorbing the impact force when the door is fully opened. It is worth to mention a safety distance, which is larger than the length of the door knob 30, is defined as the distance between the biasing side 524 and the stopping side 523, namely the length of the stopper article 520.

Generally speaking, the present invention provides a fastening-free door stopper so as to allow the user thereof simply hangs the door stopper at the neck portion of the door knob to prevent the door from hitting the nearby wall when it is fully opened. Furthermore, in contrast to conventional door stoppers, the impacting head of the stopper article and even the entire body of the hanging device can be painted with animation figures or pictures, so the aesthetic value of the door stopper in the present invention is significantly enhanced. In addition, since the hanging panel and the stopper article are made either by plastic, soft materials or foaming materials, the manufacturing costs of the door stopper are reduced, so as to allow the purchasers to buy the door stopper at a lower price without sacrificing the essential functions thereof.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fastening-free door stopper for a door having a door knob, comprising:
a hanging device adapted for coupling with said door in a tool free manner; and
a stopper article, which has a force absorbing ability, being suspendedly hung down by said hanging device, wherein said stopper article has a biasing side and an opposed stopping side and defining a safety distance between said biasing side and said stopping side larger than a length of said door knob, wherein when said stopper article is suspendedly hung, said biasing side of said stopper article is adapted for biasing against a door surface, such that said stopper article is adapted for absorbing an impact force when said door is fully opened so as to prevent said door being snapped to a nearby wall.

2. The fastening-free door stopper, as recited in claim 1, wherein said hanging device comprises a hanging panel having an upper portion, a hanging slot formed thereat for being held at a neck portion of said door knob, and a lower portion retaining said stopper article in position so as to retain said stopper article below said door knob.

3. The fastening-free door stopper, as recited in claim 2, wherein said stopper article comprises an impacting head frontwardly extended from said lower portion of said hanging panel to define said stopping side for facing towards said nearby wall when said door is opened, and a retention base rearwardly extended from said lower portion of said hanging panel to define said biasing side for biasing against said door surface.

4. The fastening-free door stopper, as recited in claim 3, wherein said retention base has a predetermined thickness corresponding to a length of said neck portion of said door knob, such that when said stopper article is being hung, said retention base retains said hanging panel at a most frontward position for preventing said hanging panel from being backwardly slid along said neck portion of said door knob.

5. The fastening-free door stopper, as recited in claim 4, wherein said hanging slot has a lower slot portion having a size slightly larger than a size of a head portion of said door knob, and an upper slot portion having a size slightly larger than a size of said neck portion of said door knob, such that said hanging panel is adapted for being hung at said door knob to retain said stopper article in position.

6. The fastening-free door stopper, as recited in claim 1, wherein said stopper article is integrally extended from said hanging device to form a one-piece structure.

7. The fastening-free door stopper, as recited in claim 5, wherein said stopper article is integrally extended from said hanging device to form a one-piece structure.

8. The fastening-free door stopper, as recited in claim 1, wherein said stopper article is made of foaming material for absorbing said impact force when said door is fully opened.

9. The fastening-free door stopper, as recited in claim 7, wherein said stopper article is made of foaming material for absorbing said impact force when said door is fully opened.

10. The fastening-free door stopper, as recited in claim 3, wherein said hanging panel further contains a holding slot provided at said lower portion, wherein said retention base of said stopper article is deformably passed through said holding slot to replaceably mount said stopper article at said lower portion of said hanging panel so as to retain said impacting head frontwardly protruding from said hanging panel and said retention base rearwardly protruding from said hanging panel.

11. The fastening-free door stopper, as recited in claim 5, wherein said hanging panel further contains a holding slot provided at said lower portion, wherein said retention base of said stopper article is deformably passed through said holding slot to replaceably mount said stopper article at said lower portion of said hanging panel so as to retain said impacting head frontwardly protruding from said hanging panel and said retention base rearwardly protruding from said hanging panel.

12. The fastening-free door stopper, as recited in claim 10, wherein said stopper article is made of foaming material for absorbing said impact force when said door is fully opened.

13. The fastening-free door stopper, as recited in claim 11, wherein said stopper article is made of foaming material for absorbing said impact force when said door is fully opened.

14. The fastening-free door stopper, as recited in claim 10, wherein said stopper article is an inflatable article for absorbing said impact force when said door is fully opened.

15. The fastening-free door stopper, as recited in claim 11, wherein said stopper article is an inflatable article for absorbing said impact force when said door is fully opened.

16. The fastening-free door stopper, as recited in claim 1, wherein said hanging device comprises a hanging cable having two ends affixing to said stopper article to define a hanging loop for being held at said neck portion of said door knob so as to retain said stopper article below said door knob.

17. The fastening-free door stopper, as recited in claim 16, wherein said stopper article comprises an impacting head having a front side as said stopping side for facing towards said nearby wall when said door is opened, and a retention base which is integrally and rearwardly extended from said impacting head to define said biasing side for biasing against said door surface, wherein said retention base has a predetermined thickness corresponding to a length of said neck portion of said door knob, such that when said stopper article is being hung, said retention base retains said hanging cable at a most frontward position for preventing said hanging cable from being backwardly slid along said neck portion of said door knob.

18. The fastening-free door stopper, as recited in claim 17, wherein said stopper article is made of foaming material for absorbing said impact force when said door is fully opened.

19. The fastening-free door stopper, as recited in claim 17, wherein said stopper article is an inflatable article for absorbing said impact force when said door is fully opened.

20. The fastening-free door stopper, as recited in claim 7, wherein said stopper article and said hanging panel are inflatable articles and are integrally formed as a one-piece door stop, such that when said door stop is inflated, an upper portion of said door stop forms said hanging panel while a lower portion of said door stop forms said hanging article.

21. The fastening-free door stopper, as recited in claim 1, wherein said hanging device comprises an edge hanger having an upper portion adapted for hanging at a top edge of said door, and a lower portion coupling with said stopper article.

22. The fastening-free door stopper, as recited in claim 21, wherein said stopper article comprises an impacting head frontwardly extended from said lower portion of said edge hanger to define said stopping side for facing towards said nearby wall when said door is opened, and a retention base rearwardly extended from said lower portion of said edge hanger to define said biasing side for biasing against said door surface.

23. The fastening-free door stopper, as recited in claim 22, wherein said stopper article is made of foaming material for absorbing said impact force when said door is fully opened.
